(19) United States
(12) Patent Application Publication
(10) Pub. No.: US 2005/0257691 A1
(43) Pub. Date: Nov. 24, 2005

(54) Apparatus and method for brewing and dispensing coffee

(76) Inventors: David Colman, Port Perry (CA); Robert Noel Buurman, Toronto (CA)

Correspondence Address: BIRCH STEWART KOLASCH & BIRCH, PO BOX 747, FALLS CHURCH, VA, 22040-0747, US

(21) Appl. No.: 10/847,386

(22) Filed: May 18, 2004

(51) Int. Cl. A47J 31/00

(52) U.S. Cl. 99/279

(57) ABSTRACT

The apparatus includes a brewing vessel for the production of coffee. There is a holding vessel to which the coffee from the brewing vessel flows. The holding vessel lacks a heater so that the temperature of the coffee falls while it is in the holding tank. An urn receives coffee from the holding tank. In the urn the coffee is re-heated to a temperature suitable for consumption. The urn has a spigot for dispensing the hot coffee. There is a control means for preventing the coffee in the holding tank from flowing to the urn while coffee is flowing from the brewing vessel to the holding tank. The method includes the steps of: contacting coffee beans in a brewing vessel with a stream of hot water over a predetermined interval of time to produce liquid coffee. From the brewing vessel the coffee flows to an unheated holding tank where it remains, unheated, until the end of the predetermined time interval. At the end of the interval, the flow of hot water to the brewing vessel stops. Cool coffee from the holding tank then flows to an urn and is reheated and is dispensed as required.

### FIELD OF THE INVENTION

This invention relates to a method of brewing and dispensing coffee and to an apparatus in which the method can be carried out. More particularly the invention relates to a method of brewing and dispensing coffee of uniform strength from a vehicle and to an apparatus for carrying out the method.

### BACKGROUND OF THE INVENTION

The strength of coffee can vary considerably depending on the point at which it is produced in the brewing cycle. Coffee produced early in the cycle tends to be stronger than coffee produced later. Where relatively little coffee is produced at a time, such as in a small automatic coffee maker, the difference in strength is usually not detectable but where large quantities are produced, such as in a coffee urn, the strength can vary considerably.

We have invented an apparatus which dispenses relatively large quantities of coffee of uniform strength no matter at what point the coffee is produced in a brewing cycle. The apparatus consists of a brewing vessel in which coffee is produced and a holding tank to which the coffee flows immediately after production. The coffee collects in the holding tank and remains there, unheated, until the brewing cycle ends. When coffee is required to be dispensed, the coffee in the holding tank is transferred to an urn where it is reheated then dispensed as required.

The coffee that is dispensed is not coffee that is brewed at that time. Rather the dispensed coffee is the coffee that is in the holding tank after the brewing cycle is complete. The strength of the coffee is accordingly uniform and is not affected by the time at which it was brewed.

The quality of coffee that is dispensed from the urn is generally better than coffee produced by conventional methods. That is because the coffee is not heated until shortly before it is ready to be dispensed. Before then it is allowed to cool. This is to be contrasted with conventional methods where the coffee remains hot from the time it is brewed to the time it is dispensed. The longer coffee remains hot, the poorer its quality tends to become.

Our coffee does not remain hot after it is brewed. Rather it is allowed to cool in the unheated holding tank. It is not heated until the brewing cycle is complete and until it is to be dispensed. It is at this time that the coffee is transferred from the holding tank to the urn where it is heated to the required temperature and immediately thereafter dispensed.

Coffee produced according to our process is of uniform strength and is more commercially acceptable where uniformity in the strength of the product is demanded by the consumer.

### SUMMARY OF THE INVENTION

Briefly, the apparatus of our invention comprises: a brewing vessel having means for the production of liquid coffee; a holding vessel to which liquid coffee from the brewing vessel flows. The holding vessel lacks heat-adding means such that the temperature of the liquid coffee while within the holding tank does not rise. The apparatus includes an urn to which liquid coffee from the holding tank heat flows and from which the liquid coffee is dispensed. Heating means is provided for heating the liquid coffee in the urn and a control means is provided for preventing the liquid coffee in the holding tank from flowing to the urn while liquid coffee is flowing from the brewing vessel to the holding tank.

The method of our invention includes the steps of: providing a first container containing coffee beans; contacting the coffee beans with a flow of hot water over a predetermined period of time to produce liquid coffee; causing the liquid coffee to flow to an unheated second container; retaining the liquid coffee in the second container, unheated, until the end of the predetermined period of time; terminating the flow of hot water to the first container at the end of the predetermined period of time; causing liquid coffee in the second container to flow to a third container while the flow of hot water to the first container is terminated; and heating liquid coffee in the third container to a temperature suitable for dispensing as a beverage.

### DESCRIPTION OF THE DRAWINGS

The method and apparatus of the invention is described with reference to the accompanying drawings in which:

FIG. 1 is a perspective view of the components of the apparatus mounted within the box of a truck;

FIG. 2 is an exploded perspective view of the components of the apparatus;

FIG. 3 is a plan view of the components; and

FIG. 4 is a perspective view of the components of the brewing vessel.

Like characters refer to like parts throughout the description of the drawings.

### DESCRIPTION OF PREFERRED EMBODIMENT

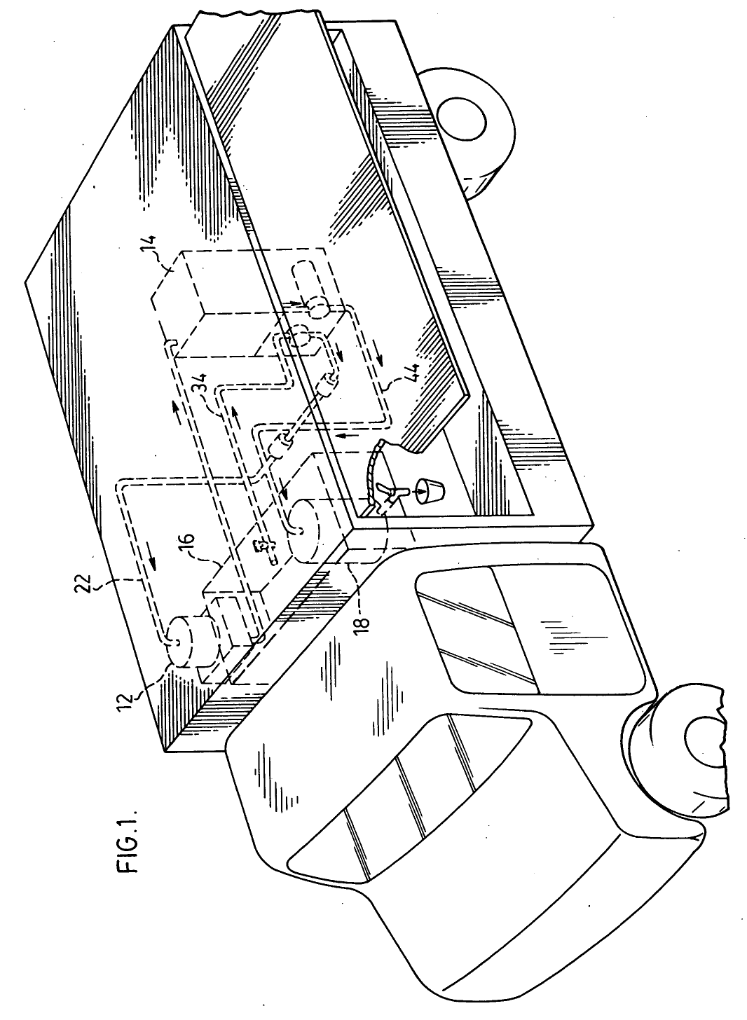

With reference to FIGS. 1 to 3, the coffee brewing and dispensing apparatus of the invention, includes a brewing vessel 12 in which coffee is brewed, a holding vessel 14 to which brewed coffee from the brewing vessel is transferred and a hot water jacket 16 in which an urn 18 is mounted. Coffee is dispensed from the urn through a tap or spigot 20 near the bottom of the hot water jacket.

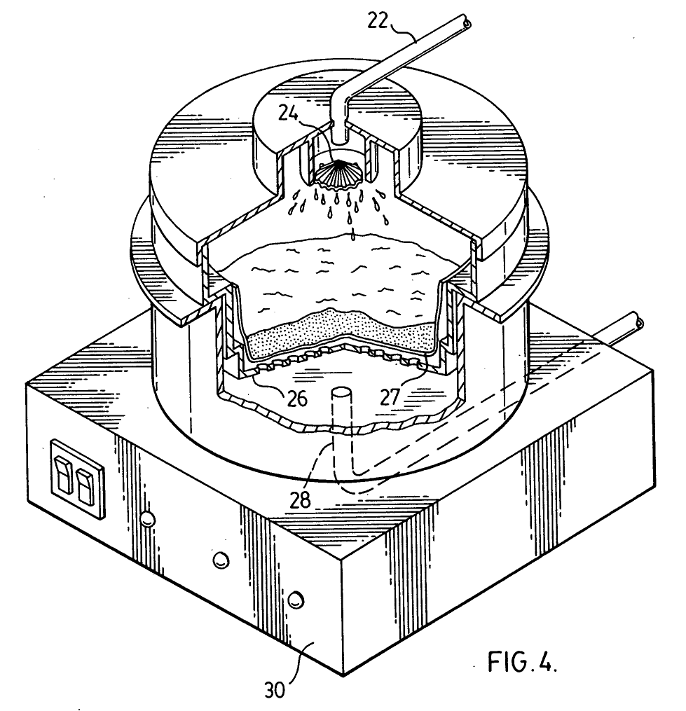

With reference to FIG. 4, the brewing vessel contains the conventional components of a coffee maker including a conduit 22 through which hot water flows and discharges onto a sprinkler head or rose 24. Droplets of hot water from the rose fall into a basket 26 on which a filter 27 is seated. Over the filter is a layer of ground coffee beans.

The hot water droplets fall downwardly through the layer of ground coffee beans, as is conventional, and emerge as brewed coffee. The brewed coffee falls on the bottom of the brewing vessel and drains into a conduit 28 where it flows by gravity into holding tank 14.

The brewing vessel is mounted on a base 30 which has controls for a timer for adjusting the period of the brewing cycle, an on/off switch and so on.

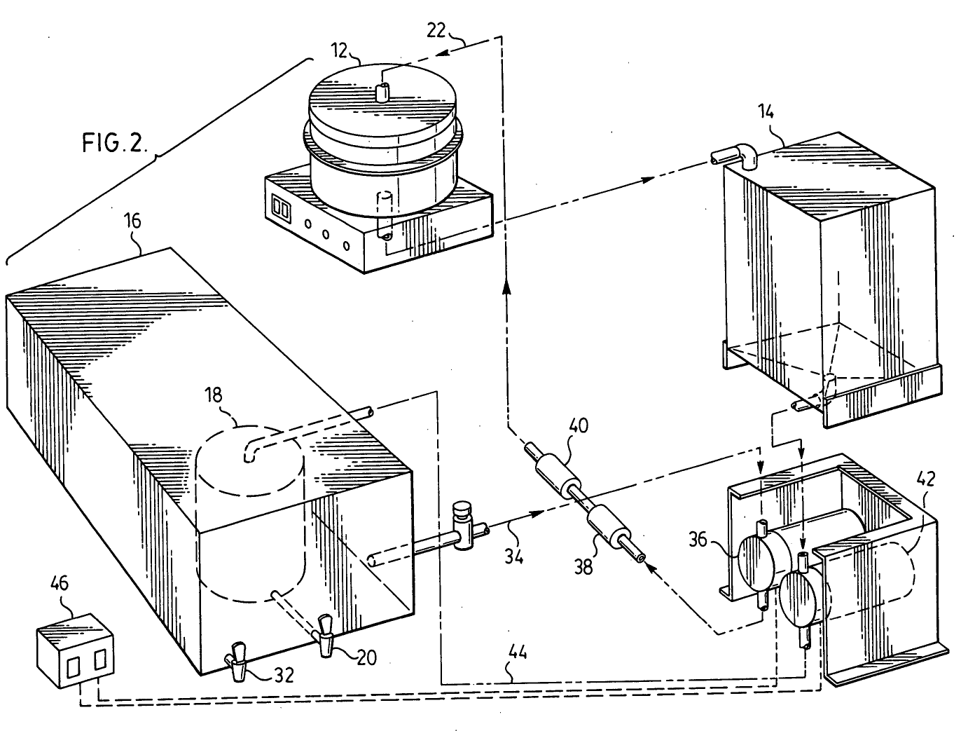

With reference to FIG. 2, the hot water which is fed to the brewing vessel is heated in hot water jacket 16. While the hot water is in the hot water jacket, it keeps the coffee in urn 18 hot. A second spigot 32 is provided for drawing hot water from the hot water jacket for making tea, for cleaning the apparatus or for other purposes.

From hot water jacket 16 the hot water flows through a conduit 34 to a pump 36 and from there it flows through conduit 22 to the brewing vessel. There is a filter 38 for removing solid impurities in the water and a flow control valve 40 for controlling the rate of flow of hot water through conduit 22 to the brewing vessel.

Liquid coffee remains in holding tank 14, unheated, until pump 42 is activated at which time the coffee flows through conduit 44 to urn 18. Switch 46 controls the operation of pump 42 as well as pump 36.

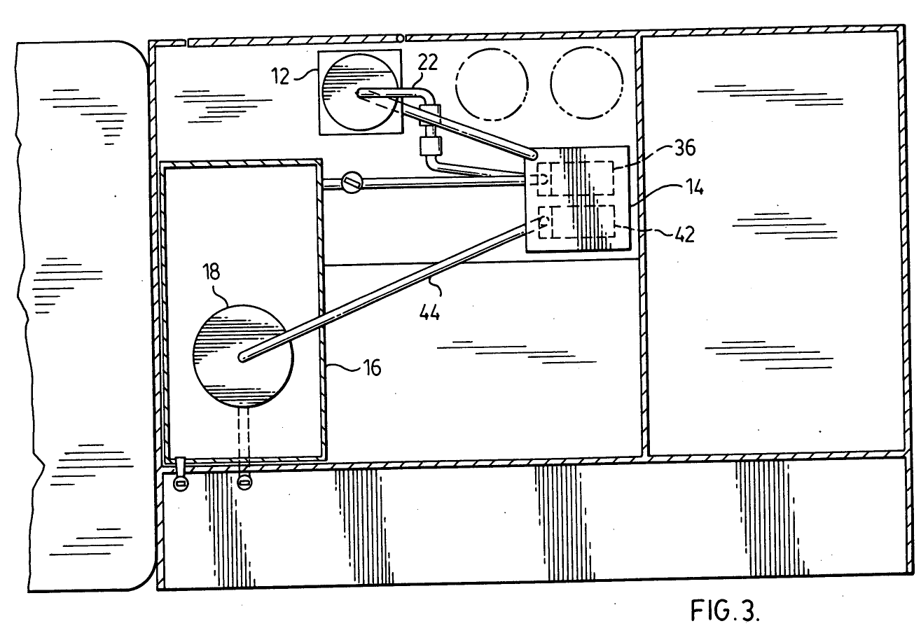

As illustrated in FIGS. 1 and 3, pumps 35, 42 are mounted beneath holding tank 14.

The quantity of water which flows into the brewing vessel during each cycle of the brewing operation is controlled according to the capacity of the holding tank, the amount of coffee beans in the basket and the amount of coffee that is required. Such control is conventional and the means for achieving it is not described since various well-known means are suitable for doing so.

As previously indicated, coffee brewed in the brewing vessel flows to holding tank 14 where it remains until pump 42 is activated. Activation occurs when the brewing cycle is complete and immediately thereafter coffee flows from the holding tank to the urn.

The term “brewing cycle” in this context and elsewhere in this application is intended to mean the brewing process from the beginning when hot water begins to flow onto the layer of coffee beans to the end when the flow of water ends.

There are various means for activating pump 42. The pump can, for example, be activated by a float valve in the holding tank. The valve opens when the level of coffee within the tank reaches a given level. At that time pump 36 must stop so that the brewing cycle will end and pump 42 will activate to transfer the coffee in the holding tank to urn 18. The holding tank will then contain all the water that flows into the brewing vessel during the brewing cycle.

Another means for activating pump 42 is a timer which is connected to and activates the pump. The timer is set by hand to measure the time required for completion of the brewing cycle. When that time has elapsed, the timer activates the pump and causes it to operate to transfer the coffee in the holding tank to the urn. The timer will also deactivate pump 36 at this time.

The time required to complete the brewing cycle will depend on a number of factors such as the capacity of the holding tank, the rate of flow of water into the brewing vessel and so on. That time can be determined simply by observing a brewing cycle and measuring the time required for it to complete.

Coffee that flows into urn 18 is kept hot by hot water in jacket 16. That water surrounds the urn, as previously indicated, and keeps its contents hot. Alternatively the contents of the urn can be kept hot by an electrical heating element (not illustrated).

The method for the production and dispensing of the coffee in the above described apparatus will including the following steps: coffee beans are added to a first container or brewing vessel 12. The coffee beans are contacted with a flow of hot water over a predetermined period of time or in a predetermined volume to produce liquid coffee. Immediately after contact, the liquid coffee flows to an unheated second container or holding tank 14 where it remains until the predetermined period of time has elapsed or the predetermined volume of hot water has contacted the beans. The flow of hot water to the brewing vessel is then terminated. Liquid coffee in the holding tank is then caused to flow to a third container or urn 18 while the flow of hot water to the brewing vessel is terminated. Liquid coffee in the urn is heated to a temperature suitable for dispensing as a beverage.

Liquid coffee in the holding tank produced during each predetermined period of time is prevented from flowing to the urn until all the liquid coffee in the urn produced from the immediately preceding predetermined period of time has been dispensed.

Liquid coffee in the holding tank is prevented from flowing to the urn until all the liquid coffee in the urn produced during the immediately preceding interval of time or from the immediately preceding volume of hot water has been dispensed.

It will be understood of course that modifications can be made in the method and apparatus described herein without departing from the scope of the invention.

1. A coffee brewing and dispensing apparatus comprising:
a brewing vessel having a filter over which a layer of ground coffee beans is adapted to lie and a sprinkler from which hot water discharges and falls onto said layer to infuse the contents thereof for the production of liquid coffee during a brewing cycle commencing when hot water first discharges from said sprinkler and terminating when the discharge ends and the contents of said coffee beans are substantially extracted,
a holding vessel to which liquid coffee from said brewing vessel flows during said brewing cycle, said holding vessel being of sufficient capacity to contain the coffee brewed in said brewing vessel during the entire brewing cycle and lacking heat-adding means such that the temperature of said liquid coffee while within said holding tank does not rise,
an urn to which liquid coffee from said holding tank flows and from which the liquid coffee is dispensed,
heating means for heating the liquid coffee in said urn; and
control means for preventing the liquid coffee in said holding tank from flowing to said urn while liquid coffee is flowing from said brewing vessel to said holding tank.

2. (canceled)

3. The apparatus of claim 1 further including second control means for terminating the flow of hot water to said brewing vessel while liquid coffee from said holding tank is flowing to said urn.

4. The apparatus of claim 1 wherein said heating means is a heating jacket containing hot water which surrounds said urn and which heats the liquid coffee therein.

5. (canceled)

6. The apparatus of claim 4 wherein the hot water within said heating means is the source of hot water which discharges from said sprinkler.

7. The apparatus of claim 6 further including a conduit through which hot water flows to said brewing vessel; means for measuring the quantity of hot water flowing to said brewing vessel and for stopping the flow when the quantity has reached a predetermined value.

8. The apparatus of claim 7 further including means for causing said measuring means to stop the flow of hot water to said brewing vessel at the time that said control means allows the brewed coffee to flow to said urn.

9. The apparatus of claim 7 further including a heating jacket containing hot water which surrounds said urn and which heats the contents thereof, the latter said hot water flowing through said conduit to said brewing vessel.

10-17. (canceled)
